(19) United States
(12) Patent Application Publication
(10) Pub. No.: US 2025/0036596 A1
(43) Pub. Date: Jan. 30, 2025

(54) Process Asynchronous Out of Memory Log Transporter for Remote Containerized Deployments

(71) Applicant: Google LLC, Mountain View, CA (US)

(72) Inventors: Alankrit Kharbanda, Mountain View, CA (US); Aj Ortega, Mountain View, CA (US)

(73) Assignee: Google LLC, Mountain View, CA (US)

(21) Appl. No.: 18/360,596

(22) Filed: Jul. 27, 2023

(51) Int. Cl. G06F 16/17; G06F 16/16

(52) U.S. Cl. CPC G06F 16/1734; G06F 16/162

(57) ABSTRACT

A method for in process asynchronous out of memory logs for remote containerized deployments includes executing a container process within a container. The method further includes, writing, by the container process, a log of the container process to a first log file. The method also includes storing, by the container process, the first log file at non-volatile memory mounted to the container. The method includes determining, by the container process, that the first log file satisfies a threshold size. In response to determining that the first log file satisfies the threshold size, the method includes writing the log of the container process to a second log file, compressing the first log file into a first compressed log file, and transmitting the first compressed log file to a remote endpoint.

### TECHNICAL FIELD

This disclosure relates to an in-process asynchronous out of memory log transporter for remote containerized deployments.

### BACKGROUND

A container is a package of software that includes all of the necessary elements to run in any environment by virtualizing an operating system. In other words, containers function as compute units which may be instantiated at a device or in a cloud environment. Containers allow for easily sharing CPU, memory, storage, and network resources at the operating systems level and offer a logical packaging mechanism in which applications can be abstracted from the environment in which they actually run. While a developer can deploy a container in a remote environment, once the container is deployed the developer generally does not have the ability to access or modify the remote environment and/or the container.

### SUMMARY

One aspect of the disclosure provides a computer-implemented method for an in-process asynchronous out of memory log transporter for remote containerized deployments. The computer-implemented method is executed by data processing hardware that causes the data processing hardware to perform operations including executing a container process within a container. During execution, the container process performs a number of operations that include writing a log of the container process to a first log file and storing the first log file at non-volatile memory mounted to the container. The operations that the container process performs also include determining that the first log file satisfies a threshold size. In response to determining that the first log file satisfies a threshold size, the container process writes the log of the container process to a second log file. The operations that the container process performs includes compressing the first log file into a first compressed log file and storing the second log file at the non-volatile memory mounted to the container and the first compressed log file at the non-volatile memory mounted to the container. The operations that the container process performs also includes transmitting the first compressed log file to a remote endpoint.

Implementations of the disclosure may include one or more of the following optional features. In some implementations, the first log file is stored within a directory. In these implementations, the directory may include a first folder storing log files before compression, a second folder storing the log files during compression, and a third folder storing the log files after compression. In these implementations, the operations may further include, in response to compressing the first log file into the first compressed log file, moving the first compressed log file from the second folder to the third folder. In these implementations, the operations may alternatively include periodically scanning the third folder for the first compressed log file. Here, the operations may further include determining that the third folder stores the first compressed log file and transmitting the first compressed log file to a remote endpoint may be in response to determining that the third folder stores the first compressed log file. In these implementations, the directory may be accessible by a plurality of containers. In some of these implementations, the operations further include determining that the second log file satisfies the threshold size, and in response to determining that the second log file satisfies the threshold size, writing the log of the container process to a third log file. These implementations include storing the third log file at the non-volatile memory mounted to the container. These implementations further include compressing the second log file into a second compressed log file and storing the second compressed log file at the non-volatile memory mounted to the container. These implementations also include determining that compressing the second log file failed, and, in response to determining that compressing the second log file failed, deleting the second compressed log file from the non-volatile memory mounted to the container. These implementations include compressing the second log file into a new second compressed log file and storing the new second compressed log file at the non-volatile memory mounted to the container. In these implementations, the operations may further include, in response to determining that compressing the second log file failed, compressing, by a second container process of a second container of the plurality of containers, the second log file.

The operations may further include in response to transmitting the first compressed log file to the remote endpoint, deleting the first compressed log file from the non-volatile memory mounted to the container.

Another aspect of the disclosure provides a system for an in-process asynchronous out of memory log transporter for remote containerized deployments. The system includes data processing hardware and memory hardware in communication with the data processing hardware. The memory hardware stores instructions that when executed on the data processing hardware cause the data processing hardware to perform operations. The operations include executing a container process within a container. During execution, the container process performs a number of operations that include writing a log of the container process to a first log file and storing the first log file at non-volatile memory mounted to the container. The operations that the container process performs also include determining that the first log file satisfies a threshold size. In response to determining that the first log file satisfies a threshold size, the container process writes the log of the container process to a second log file. The operations that the container process performs includes compressing the first log file into a first compressed log file and storing the second log file at the non-volatile memory mounted to the container and the first compressed log file at the non-volatile memory mounted to the container. The operations that the container process performs also includes transmitting the first compressed log file to a remote endpoint.

This aspect may include one or more of the following optional features. In some implementations, the first log file is stored within a directory. In these implementations, the directory may include a first folder storing log files before compression, a second folder storing the log files during compression, and a third folder storing the log files after compression. In these implementations, the operations may further include, in response to compressing the first log file into the first compressed log file, moving the first compressed log file from the second folder to the third folder. In these implementations, the operations may alternatively include periodically scanning the third folder for the first compressed log file. Here, the operations may further include determining that the third folder stores the first compressed log file and transmitting the first compressed log file to a remote endpoint may be in response to determining that the third folder stores the first compressed log file. In these implementations, the directory may be accessible by a plurality of containers. In some of these implementations, the operations further include determining that the second log file satisfies the threshold size, and in response to determining that the second log file satisfies the threshold size, writing the log of the container process to a third log file. These implementations include storing the third log file at the non-volatile memory mounted to the container. These implementations further include compressing the second log file into a second compressed log file and storing the second compressed log file at the non-volatile memory mounted to the container. These implementations also include determining that compressing the second log file failed, and, in response to determining that compressing the second log file failed, deleting the second compressed log file from the non-volatile memory mounted to the container. These implementations include compressing the second log file into a new second compressed log file and storing the new second compressed log file at the non-volatile memory mounted to the container. In these implementations, the operations may further include, in response to determining that compressing the second log file failed, compressing, by a second container process of a second container of the plurality of containers, the second log file.

The operations may further include in response to transmitting the first compressed log file to the remote endpoint, deleting the first compressed log file from the non-volatile memory mounted to the container.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for an in-process asynchronous out of memory log transporter for remote containerized deployments.

FIG. 2 is a schematic view of an example sequence diagram for an in process asynchronous out of memory log transporter for remote containerized deployments

FIG. 3 a flowchart of an example arrangement of operations for a method of an in-process asynchronous out of memory log transporter for remote containerized deployments.

FIG. 4 is a schematic view of an example computing device that may be used to implement the systems and methods described herein.

Like reference symbols in the various drawings indicate like elements.

### DETAILED DESCRIPTION

Remote deployed containers are difficult to manage with regard to creation and transfer of logs. A container generally refers to operating system (OS) level virtualization within an isolated user space instance. As a developer no longer has access to the device on which a container is executing, the developer cannot simply deploy a background process to write or transfer logs. Current solutions involve storing logs at the container and asynchronously transferring the log once the container has finished executing. However, as these logs end up being quite large, these current solutions are computationally expensive, use excessive memory resources, and clog bandwidth during transfer.

Implementations herein are aimed at an in-process asynchronous out of memory log transporter for remote containerized deployments. In other words, some implementations include writing and transferring logs during the execution of the container which is resource efficient. In particular, during execution of a container process (i.e., the process executing within a container of a container orchestration environment), the container process includes writing a log to a log file until the log file reaches a threshold size. Once the log file reaches the threshold size, the container process begins writing the log to a new log file. The container process also includes compressing the original log file once it reaches the threshold size and then transmitting the compressed log file to an intended source destination.

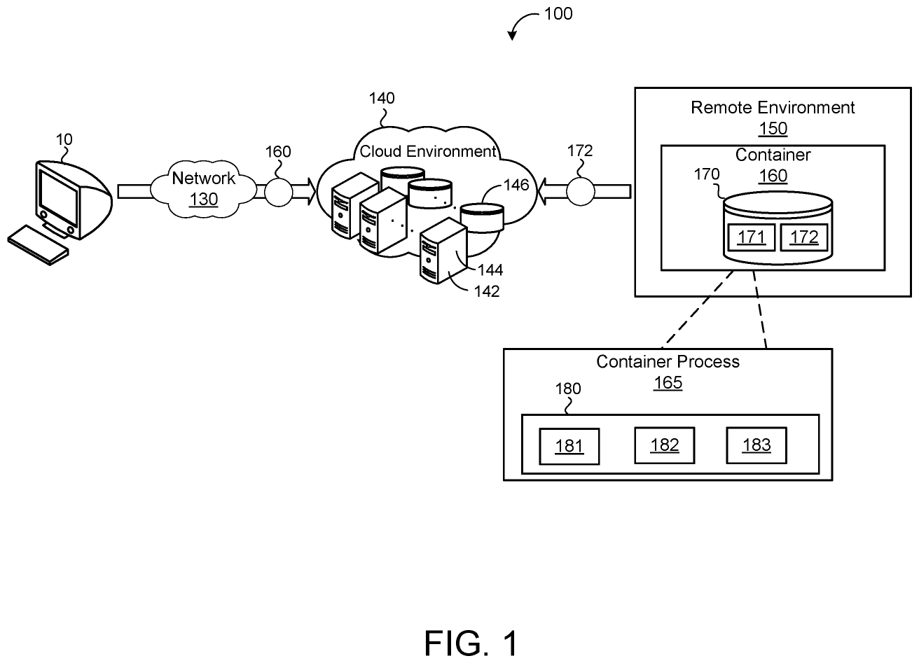

Referring to FIG. 1, in some implementations, an in-process asynchronous out of memory log transporter for remote containerized deployments system 100 includes a client device 10 communicatively coupled to a cloud environment 140 through a network 130. The cloud environment 140 may be a single computer, multiple computers, or a distributed system having scalable/elastic resources 142 including computing resources 144 (e.g., data processing hardware) and/or storage resources 146 (e.g., memory hardware). The cloud environment 140 may be configured to transmit a container 160 from a user device 10 to a remote environment 150.

The user device 10 may be any device suitable to generate and deploy a container such as a computer, a tablet, a laptop, etc. A developer of the user device 10 transmits the container 210 for deployment at a remote environment 150. The remote environment 150 may be any suitable computing environment such as a computer, a cloud environment (i.e., cloud environment 140), etc. The container may include storage 170 (i.e., non-volatile memory such as a hard disk or solid state drive) to store one or more log files 171 and one or more compressed log files 172. The storage 170 may include a directory of folders, where at least one folder of the directory stores log files 171 before compression, at least one folder of the directory stores log files 171 during compression (i.e., while the log file 171 is undergoing compression), and at least one folder of the directory stores compressed log files 172 (i.e., after the log file 171 has finished compression). In some implementations the storage 170 is mounted to the container 160 or otherwise accessible to the processes executing within the container 160. Further, the storage 170 may be shared storage of a plurality of containers 160 in the remote environment 150. The storage 170 can be physical storage when the remote environment 150 is a computing device or cloud storage when the remote environment 150 is a cloud environment.

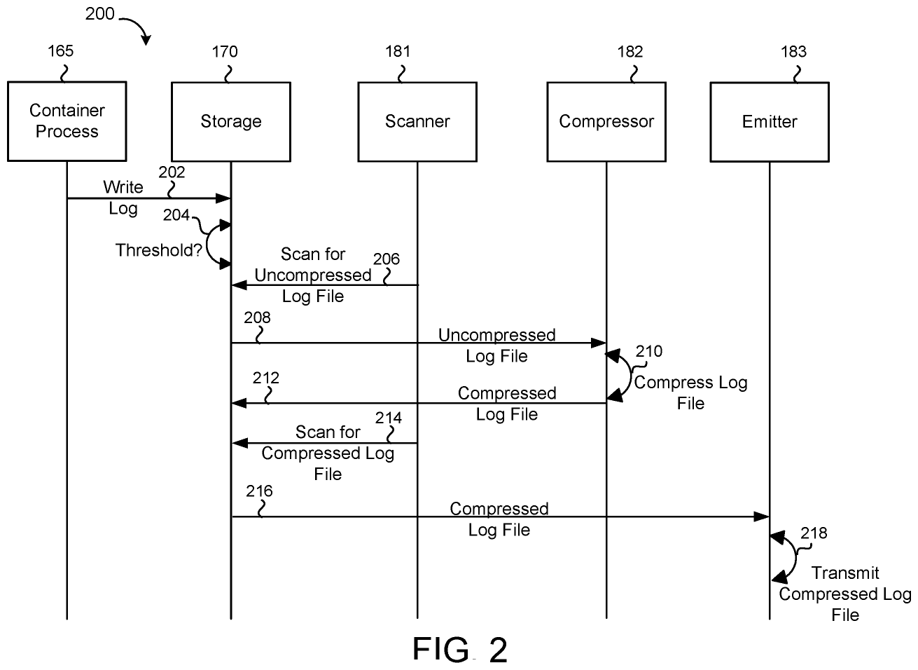

The remote environment 150 executes a container process 165 within the container 160. The container process may include a transporter module 180 to manage and transfer log files 171 and compressed log files 172. In particular, the transporter module 180 may include a scanner 181, a compressor 182, and an emitter 183. The components of the transporter module 180 are discussed in greater detail below (FIG. 2).

FIG. 2 is a schematic view of a sequence diagram 200 for an in-process asynchronous out of memory log transporter for remote containerized deployments. At step 202, the container process 165 writes a log to a log file 171, stored at the storage 170. At step 204, the container process 165 determines if the log file 171 satisfies a threshold. For example, the threshold may be a maximum size of the log file 171, such as 100 MB. Once the log file 171 satisfies the threshold (e.g., the log file 171 meets or exceeds the maximum size), the container process 165 may begin writing the log to a new log file 171 (i.e., repeating step 202).

At step 206, the scanner 181 scans for uncompressed log files 171 in the storage 170. The scan may be periodic (e.g., once a minute, once an hour, etc.) or in response to satisfaction of a condition (e.g., the container process 165 completes a task). In some implementations, the storage 170 is a directory and includes a folder specifically for uncompressed log files 171. If the scanner 181 determines that there are uncompressed log files 171 in the storage 170, at step 208 the compressor 182 may retrieve the uncompressed log file(s) 171. At step 210, the compressor 182 compresses the uncompressed log files 171. In some implementations, the compressor 182 writes the compressed log files 172 to another folder in the directory of the storage 170. In these implementations, if the compressor 182 fails while compressing the log file 171 (i.e., the container process 165 and/or container 160 fails), the folder will include an incomplete compressed file 172. In this scenario, the compressor 182 may delete the incomplete compressed file 172 and begin recompressing the log file 171. Alternatively, when the storage is accessible by multiple containers 160/container processes 165, another compressor 182 of a different container process 165 (i.e., a container process 165 executed within a different container 160) may delete the incomplete compressed file 172 and begin recompressing the log file 171. In this manner, the log will not be lost, even if the compressor 182 (i.e., container process 165) that wrote the original log file 171 becomes corrupt and/or fails.

At step 212, the compressor 182 stores the compressed log file 172 at the storage 170. In some implementations, the compressor 182 deletes log files 171 once a corresponding compressed log file 172 has been generated. In some implementations, the storage 170 includes a folder for compressed log file 172. At step 214, the scanner 181 scans storage 170 for compressed log files 172. In some implementations, the scanner 181 periodically scans the storage for uncompressed log files 171 and compressed log files 172 periodically throughout the duration of the container process 165. At step 216, an emitter 183 retrieves the compressed log files 172 from the storage 170. At step 218, the emitter 183 transmits the compressed log file 172 to an end point. The emitter 183 may transmit the compressed log file 172 to any appropriate endpoint designated by the user device 10, such as a physical storage, a cloud storage, an NFS endpoint, etc.

In some implementations, the sequence diagram 200 repeats as necessary during the execution of the container process 165. In other words, the container process 165 may write the log to a first log file 171 until the first log file 171 satisfies the threshold. The container process 165 may then compress the first log file 171 and then transmit the corresponding first compressed log file 172. Further, once the first log file 171 satisfies the threshold, the container process 165 begins writing the log to a second log file 171, which will be compressed and transmitted once the second log file 171 satisfies the threshold. The process can then continue to a third log file 171, a fourth log file 171, etc.

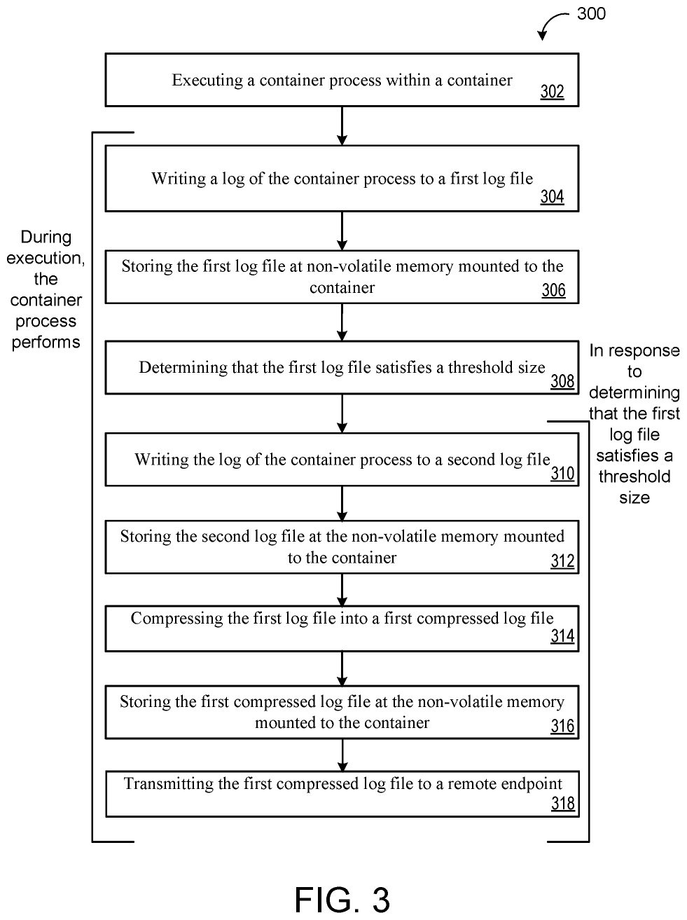

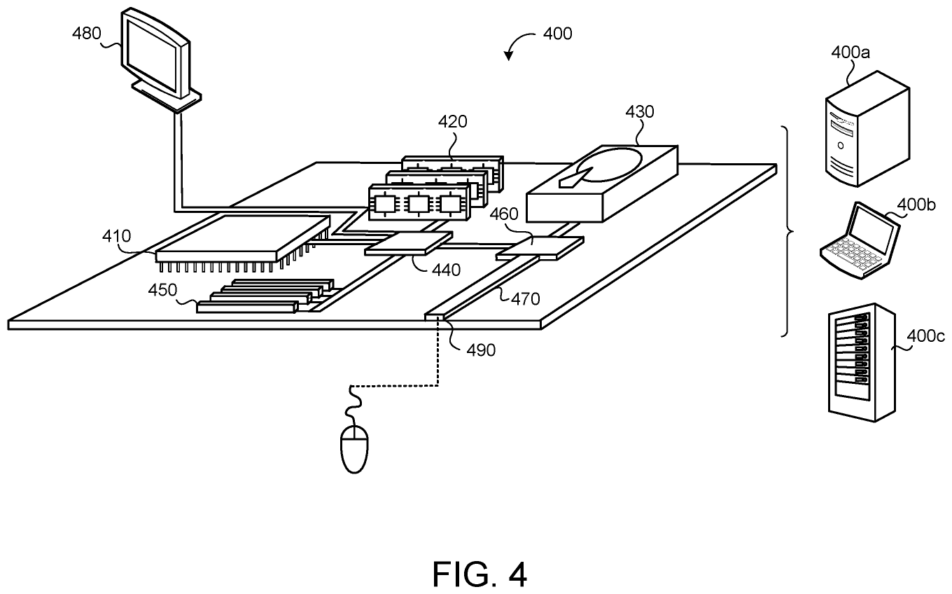

FIG. 3 is a flowchart of an exemplary arrangement of operations for a method 300 of an in-process asynchronous out of memory log transporter for remote containerized deployments. The method 300 can be performed by various interconnected computing devices such as the components of the system 100 of FIG. 1 and/or the computing device 400 of FIG. 4. At operation 302, the method 300 includes executing a container process 165 within a container 160. During execution, the container process performs operations 304, 306, 308, 310, 312, 314, 316, and 318 of method 300. At operation 304, the method 300 includes writing a log of the container process 165 to a first log file 171. At operation 306, the method 300 includes storing the first log file 171 at non-volatile memory 170 mounted to the container 160. At operation 308, the method 300 includes determining that the first log file 171 satisfies a threshold size. In response to determining that the first log file 171 satisfies the threshold size, the container process 165 executes operations 310, 312, 314, 316, and 318 of method 300. At operation 310, the method 300 includes writing the log of the container process 165 to a second log file 171. At operation 312, the method 300 includes storing the second log file 171 at the non-volatile memory mounted 170 to the container 160. At operation 314, the method 300 includes compressing the first log file 171 into a first compressed log file 172. At operation 316, the method 300 includes storing the first compressed log file 172 at the non-volatile memory 170 mounted to the container 160. At operation 318, the method 300 includes transmitting the first compressed log file 172 to a remote endpoint.

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
executing a container process within a container; and
during execution, the container process performs operations comprising:
writing a log of the container process to a first log file;
storing the first log file at non-volatile memory mounted to the container;
determining that the first log file satisfies a threshold size; and
in response to determining that the first log file satisfies the threshold size:
writing the log of the container process to a second log file;
storing the second log file at the non-volatile memory mounted to the container;
compressing the first log file into a first compressed log file;
storing the first compressed log file at the non-volatile memory mounted to the container; and
transmitting the first compressed log file to a remote endpoint.

2. The method of claim 1, wherein the first log file is stored within a directory.

3. The method of claim 2, wherein the directory comprises:
a first folder storing log files before compression;
a second folder storing the log files during compression; and
a third folder storing the log files after compression.

4. The method of claim 3, wherein the operations further comprise, in response to compressing the first log file into the first compressed log file, moving the first compressed log file from the second folder to the third folder.

5. The method of claim 3, wherein the operations further comprise periodically scanning the third folder for the first compressed log file.

6. The method of claim 5, wherein:
the operations further comprise determining that the third folder stores the first compressed log file; and
transmitting the first compressed log file to a remote endpoint is in response to determining that the third folder stores the first compressed log file.

7. The method of claim 3, wherein the directory is accessible by a plurality of containers.

8. The method of claim 7, wherein the operations further comprise:
determining that the second log file satisfies the threshold size; and
in response to determining that the second log file satisfies the threshold size:
writing the log of the container process to a third log file;
storing the third log file at the non-volatile memory mounted to the container;
compressing the second log file into a second compressed log file;
storing the second compressed log file at the non-volatile memory mounted to the container;
determining that compressing the second log file failed; and
in response to determining that compressing the second log file failed:
deleting the second compressed log file from the non-volatile memory mounted to the container;
compressing the second log file into a new second compressed log file; and
storing the new second compressed log file at the non-volatile memory mounted to the container.

9. The method of claim 8, wherein the operations further comprise, in response to determining that compressing the second log file failed, compressing, by a second container process of a second container of the plurality of containers, the second log file.

10. The method of claim 1, wherein the operations further comprise, in response to transmitting the first compressed log file to the remote endpoint, deleting the first compressed log file from the non-volatile memory mounted to the container.

11. A system comprising:
data processing hardware; and
memory hardware in communication with the data processing hardware, the memory hardware storing instructions that when executed on the data processing hardware cause the data processing hardware to perform operations comprising:
executing a container process within a container; and
during execution, the container process performs operations comprising:
writing a log of the container process to a first log file;
storing the first log file at non-volatile memory mounted to the container;
determining that the first log file satisfies a threshold size; and
in response to determining that the first log file satisfies the threshold size:
writing the log of the container process to a second log file;
storing the second log file at the non-volatile memory mounted to the container;
compressing the first log file into a first compressed log file;
storing the first compressed log file at the non-volatile memory mounted to the container; and
transmitting the first compressed log file to a remote endpoint.

12. The system of claim 11, wherein the first log file is stored within a directory.

13. The system of claim 12, wherein the directory comprises:
a first folder storing log files before compression;
a second folder storing the log files during compression; and
a third folder storing the log files after compression.

14. The system of claim 13, wherein the operations further comprise, in response to compressing the first log file into the first compressed log file, moving the first compressed log file from the second folder to the third folder.

15. The system of claim 13, wherein the operations further comprise periodically scanning the third folder for the first compressed log file.

16. The system of claim 15, wherein:
the operations further comprise determining that the third folder stores the first compressed log file; and
transmitting the first compressed log file to a remote endpoint is in response to determining that the third folder stores the first compressed log file.

17. The system of claim 13, wherein the directory is accessible by a plurality of containers.

18. The system of claim 17, wherein the operations further comprise:
determining that the second log file satisfies the threshold size; and
in response to determining that the second log file satisfies the threshold size:
writing the log of the container process to a third log file;
storing the third log file at the non-volatile memory mounted to the container;
compressing the second log file into a second compressed log file;
storing the second compressed log file at the non-volatile memory mounted to the container;
determining that compressing the second log file failed; and
in response to determining that compressing the second log file failed:
deleting the second compressed log file from the non-volatile memory mounted to the container;
compressing the second log file into a new second compressed log file; and
storing the new second compressed log file at the non-volatile memory mounted to the container.

19. The system of claim 18, wherein the operations further comprise, in response to determining that compressing the second log file failed, compressing, by a second container process of a second container of the plurality of containers, the second log file.

20. The system of claim 11, wherein the operations further comprise, in response to transmitting the first compressed log file to the remote endpoint, deleting the first compressed log file from the non-volatile memory mounted to the container.
